(19) United States
(12) Patent Application Publication
(10) Pub. No.: US 2011/0243364 A1
(43) Pub. Date: Oct. 6, 2011

(54) Structure of loudspeaker for reducing thickness and mounting depth

(76) Inventor: James J. Walter, Torrance, CA (US)

(21) Appl. No.: 13/065,853

(22) Filed: Mar. 31, 2011

Related U.S. Application Data
(60) Provisional application No. 61/319,394, filed on Mar. 31, 2010.

(51) Int. Cl. H04R 1/00

(52) U.S. Cl. 381/397; 381/398

(57) ABSTRACT

A structure of a loudspeaker is designed to decrease a thickness or height thereof, thereby reducing a mounting depth of the loudspeaker on a mounting panel or wall. The loudspeaker includes a speaker frame, a diaphragm connected to the speaker frame in a manner capable of vibration, a voice coil connected to the diaphragm through a coil bobbin to receive an electric signal to vibrate the diaphragm, a spider connected to the speaker frame and to the diaphragm for supporting the diaphragm and the voice coil in a flexible manner, a magnetic assembly including a top plate, a permanent magnet and a pole piece for creating a magnetic circuit for interaction with the voice coil inserted in an air gap, and a plurality of cut-outs formed on a top of the magnetic assembly at an outside thereof to receive therein corresponding suspension elements of the spider.

This application claims the benefit of U.S. Provisional Patent Application Ser. No. 61/319,394 filed Mar. 31, 2010, entitled “SHALLOW LOUDSPEAKER”, which is incorporated by reference herein for all purposes.

### FIELD OF THE INVENTION

This invention relates to a loudspeaker, and more particularly, to a structure of a loudspeaker to decrease a thickness or height thereof, thereby reducing a depth for mounting the loudspeaker on a panel or wall.

### BACKGROUND OF THE INVENTION

Loudspeakers are well known in the art and are commonly used in a variety of applications, such as in home theater stereo systems, car audio systems, indoor and outdoor concert halls, and the like. Those who want to enjoy a very large volume of sound produced by such a car audio system typically mount several loudspeakers in the car to enjoy the large sound when driving the car. A loudspeaker includes an acoustic transducer comprised of an electro-mechanical device which converts an electrical signal into acoustical energy in the form of sound waves and an enclosure for directing the sound waves produced upon application of the electrical signal.

An example of structure in the conventional loudspeaker is shown in FIG. 1. As shown in the cross sectional view of FIG. 1, a loudspeaker 11 includes a speaker cone 13 forming a diaphragm 17, a coil bobbin 25, and a dust cap 15. The diaphragm 17, the dust cap 15 and the coil bobbin 25 are attached to one another. A voice coil 27 is attached to the coil bobbin 25 around its surface. The voice coil 27 is connected to suitable cables (not shown) to receive an electrical input signal through electrical terminals.

The diaphragm 17 is provided with an upper half roll 21 at its peripheral made of flexible material. The diaphragm 17 connects to a speaker frame 19 at an upper half roll 21 by means of, for example, an adhesive. At about the middle of the speaker frame 19, the intersection of the diaphragm 17 and the coil bobbin 25 is connected to the speaker frame 19 through a spider 23 which works as an inner suspension. The spider 23 is typically made of a flexible material for flexibly suspending the diaphragm 17 and the coil bobbin 25. Consequently, the upper half roll 21 and the spider 23 allow the flexible vertical movements of the diaphragm 17 as well as limit or damp the amplitudes (movable distance in an axial direction) of the diaphragm 17 when it vibrates in response to the electrical input signal.

An air gap 41 and annular members including a pole piece (yoke) 39, a permanent magnet 33, and an upper plate (top plate) 35 make up a magnetic assembly 37. In this example, the magnetic assembly 37 has a back plate 38 integrally formed with the pole piece 39 at its bottom. The pole piece 39 has a central opening 40 for dissipating heat generated by the voice coil 27 when the electric power (input signal) is supplied to the voice coil 27.

In this example of magnetic assembly 37, the permanent magnet 33 is disposed between the upper plate 35 and the back plate 38 of the pole piece 39. The upper plate 35 and the pole piece 39 are constructed from a material capable of carrying magnetic flux, such as steel. Therefore, a magnetic path or circuit is created in the magnetic assembly 37, i.e., through the pole piece 39, the upper plate 35, the permanent magnet 33 and the back plate 38 through which the magnetic flux runs.

The air gap 41 is created between the pole piece 39 and the upper plate 35 in which the voice coil 27 and the coil bobbin 25 are inserted in the manner shown in FIG. 1. Thus, when the electrical input signal is applied to the voice coil 27, the current flowing in the voice coil 27 and the magnetic flux (flux density) interact with one another. This interaction produces a force on the voice coil 27 which is proportional to the product of the current and the flux density. This force activates the reciprocal movement of the voice coil 27 on the coil bobbin 25, which vibrates the diaphragm 17, thereby producing the sound waves, i.e., converting an electrical signal into acoustical energy.

Recent trends in the audio systems market have been leaning towards loudspeakers for use in a very compact/shallow space. Namely, loudspeakers of small thickness or height are desired so that they can be mounted on a shallow space of a mounting panel or wall. The need for shallow, low profile speakers are not only limited to home audio use, but also in cars, boats, airplanes and other locations that will benefit from the depth reduction without suffering a sound quality and pressure level.

Therefore, there is a need for a new and improved structure to reduce the mounting depth of the loudspeaker, but still maintain the loudspeaker's high excursion and low distortion property.

### SUMMARY OF THE INVENTION

It is an object of the present invention to provide a structure of a loudspeaker to decrease a thickness or height thereof, thereby reducing a depth for mounting the loudspeaker on a panel or wall.

It is another object of the present invention to provide a structure of a loudspeaker to reduce the mounting depth of the loudspeaker while maintaining a high excursion performance of the loudspeaker.

It is a further object of the present invention to provide a novel design to remove mechanical clearance of the loudspeaker by allowing the spider to pass through cut-outs formed on a magnetic assembly.

It is a further object of the present invention to provide a structure of the loudspeaker in which a spider is allowed to be placed further away from the diaphragm to improve axial stability so that the loudspeaker is less prone to “rocking” which may affect the loudspeaker's sensitivity and reliability.

One aspect of the present invention is a structure of a loudspeaker which is capable of decreasing a thickness or height so that it can be mounted in a shallow space of a panel or wall. The loudspeaker includes: a speaker frame; a diaphragm connected to the speaker frame in a manner capable of vibration; a voice coil connected to the diaphragm through a coil bobbin to receive an electric signal to vibrate the diaphragm; a spider connected to the speaker frame at one end and to the diaphragm at another end for supporting the diaphragm and the voice coil in a flexible manner; a magnetic assembly including a top plate, a permanent magnet and a pole piece for creating a magnetic circuit for interaction with the voice coil inserted in an air gap of the magnetic assembly; and a plurality of cut-outs formed on a top of the magnetic assembly at an outside thereof with respect to the air gap to receive therein corresponding suspension elements of the spider.

The loudspeaker further includes a central opening formed at a center of the magnetic assembly in an axial direction to dissipate heat generated by the voice coil. The magnetic assembly includes a back plate which is integrally formed with the pole piece. The air gap of the magnetic assembly to receive the voice coil is created between the pole piece and a combination of the top plate, the permanent magnet, and the back plate.

In the loudspeaker of the present invention, the magnetic assembly is configured so that the pole piece is positioned at an inside of the magnetic assembly with respect to a center axis while the combination of the top plate, the permanent magnet and the back plate is positioned at an outside of the magnetic assembly with respect to the center axis. In this structure of the magnetic assembly, the plurality of cut-outs for receiving the suspension elements of the spider are formed on the top plate of the magnetic assembly.

Alternatively, in the loudspeaker of the present invention, the magnetic assembly is configured so that the pole piece is positioned at an outside of the magnetic assembly with respect to a center axis while the combination of the top plate, the permanent magnet and the back plate is positioned at an inside of the magnetic assembly with respect to the center axis. In this structure of the magnetic assembly, the plurality of cut-outs for receiving the suspension elements of the spider are formed on a top of the pole piece of the magnetic assembly.

In the loudspeaker, a size of the cut-outs for receiving the suspension elements of the spider and a position of the spider are determined so that the suspension element of the spider will not touch the magnetic assembly when vibration amplitudes of the voice coil reach a lowermost position in the air gap during the operation of the loudspeaker.

In the loudspeaker of the present invention, the spider has an inner ring and an outer ring between which a plurality of suspension elements are connected. The inner ring of the spider is connected to the coil bobbin having the voice coil thereon, and the outer ring of the spider is connected to the speaker frame. Each of the suspension elements of the spider is made of elastic material and has a wave-like shape. A width of each suspension element is increased toward the outer ring while the width of the suspension element is decreased toward the inner ring to be inserted in the cut-out formed on the magnetic assembly.

In the loudspeaker of the present invention, the speaker frame includes an upper speaker frame and a lower speaker frame, wherein the diaphragm is mounted on the upper speaker frame, and the magnetic assembly and the spider are mounted on the lower speaker frame.

In the loudspeaker of the present invention, the diaphragm includes diaphragm frames which are aligned with the suspension elements of the spider close to one another so that both the diaphragm frames and the suspension elements are inserted in the cut-outs on the magnetic assembly when assembled, thereby increasing mechanical strength of the diaphragm.

According to the present invention, on the top of the magnetic assembly, a plurality of cut-outs (magnetic gap) are provided to receive corresponding suspension elements of the spider. Thus, each of the suspension elements can be inserted in an inside space of the cut-out when the loudspeaker is assembled, which makes it possible to dramatically reduce the distance between the diaphragm and the magnetic assembly. Consequently, it is possible to dramatically reduce the vertical length of the coil bobbin, thereby dramatically reducing the thickness, i.e., mounting depth, of the loudspeaker. The basic concept of the present invention can be applied to a variety of loudspeakers, ranging from mid-range, coaxial speakers, all the way to high-excursion subwoofers.

The present invention together with the above and other advantages may best be understood from the following detailed description of the embodiments of the invention illustrated in the drawings below.

### BRIEF DESCRIPTION OF THE DRAWINGS

FIG. 1 is a cross sectional view showing an example of inner structure and basic components of a loudspeaker in the conventional technology.

FIGS. 2A and 2B are cross sectional views showing examples of inner structure of a loudspeaker in the present invention where cut-outs are formed on the top of a magnetic assembly. In FIG. 2A, the magnetic assembly is constructed in the same way as that of FIG. 1 so that the permanent magnet is positioned outside while in FIG. 2B, the magnetic assembly is constructed in the inverted way to that of FIGS. 1 and 2A so that the permanent magnet is positioned inside.

FIG. 3 is a perspective view showing an example of the spider and the magnetic assembly incorporated in the loudspeaker of the present invention, which is viewed from the lower position.

FIG. 4 is a perspective view showing an example of outer structure of the magnetic assembly incorporated in the loudspeaker of the present invention, which is viewed from the upper position.

FIG. 5 is a perspective view showing an example of a more detailed structure of the spider incorporated in the loudspeaker of the present invention.

FIG. 6 is a perspective view showing an example of structure of a loudspeaker implementing the present invention in which an upper part and a lower part are separated from one another to show an inner structure the loudspeaker.

FIG. 7 is a perspective view showing the lower part of the structure of the loudspeaker implementing the present invention which includes the magnetic assembly and the lower speaker frame.

FIG. 8 is a perspective view showing the inner structure of the loudspeaker implementing the present invention which includes the magnetic assembly, the upper and lower speaker frames, and the spider.

FIG. 9 is a cross sectional view showing an example of inner structure and outer shape of the loudspeaker to illustrate the effect of the present invention in comparison with the conventional structure of FIG. 10.

FIG. 10 is a cross sectional view showing an example of inner structure and outer shape of the loudspeaker in the conventional technology.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As noted above, the present invention is directed to a structure of a loudspeaker for reducing its height or thickness so that it can be mound in a shallow space of a wall or panel. A typical loudspeaker has its thickness (depth) determined by the following three factors: (1) mechanical excursion which is a length of stroke (reciprocal movement) of the voice coil; (2) material thicknesses, for example, magnet and plate thicknesses, cone (diaphragm) angle/depth, etc.; and (3) mechanical clearances, for example, clearance between moving parts and safety margin).

It may be difficult to change the factors (1) and (2) since the material thickness is largely tied to the efficiency of the magnetic circuit and the excursion of the loudspeaker (voice coil), which is directly related to the output sounds at low frequencies. As to the mechanical clearance, in order to maintain reliability and customer satisfaction (i.e., no hard crashing of mechanical parts), loudspeakers have always been constrained by allowing magnetic excursion plus a safety margin for over-excursion from over-powering or use in incorrect enclosures, such that the loudspeaker may have to be deep and bulky.

The conventional loudspeaker requires mechanical clearances for both the surround (the top suspension member) to the spider (lower suspension member) and the spider to the top plate/yoke (the upper outer component of the magnetic assembly). More specifically, the surround-to-spider clearance is necessary to have adequate axial stability, as well as a mechanical interference free design. Also, the spider-to-top plate/yoke clearance is required for the downward travel of the circular spider to control the voice coil. In order to reduce the mounting depth of the loudspeaker, either the surround-to-spider clearance or the spider-to-top plate/yoke clearance may have to be eliminated or significantly reduced.

The inventor of the present invention has paid a special attention to the structure of loudspeaker related to the structure of spider. A spider is a suspension member and connects from the voice coil (and diaphragm) to the frame of the speaker to allow the flexible vertical movements of the diaphragm as well as to limit or damp the movements of the diaphragm when it is vibrated. The spider is formed with a plurality of suspension elements and is mounted on the speaker frame in such a way that the suspension elements do not touch the magnetic assembly.

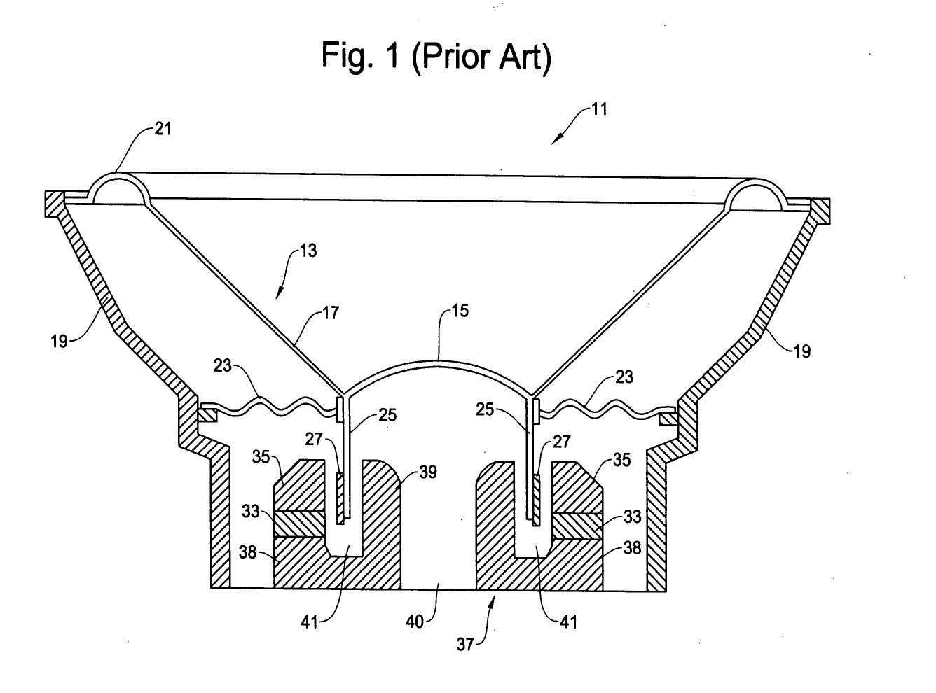

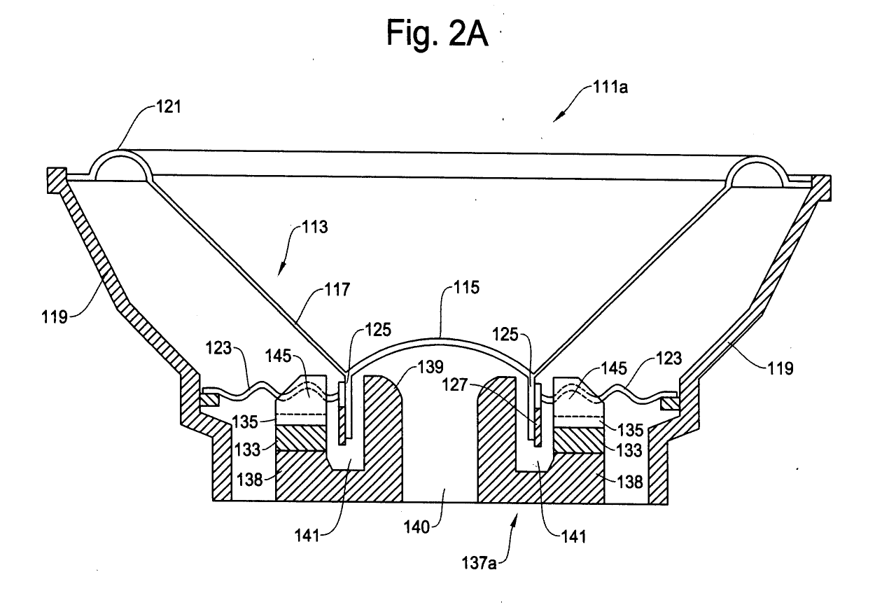

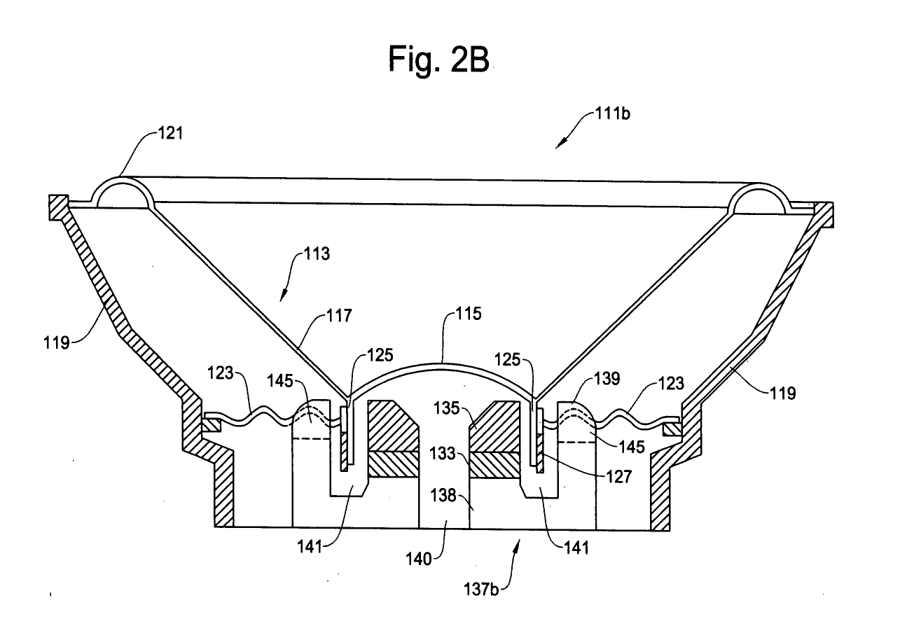

FIGS. 2A and 2B are cross sectional views showing examples of inner structure of loudspeakers in the present invention where cut-outs are formed on the top of a magnetic assembly. In the example of FIG. 2A, the magnetic assembly is constructed in the same way as that of FIG. 1 so that the permanent magnet is provided at an outside of the magnetic assembly and the pole piece is provided at an inside of the magnetic assembly. In the example of FIG. 2B, the magnetic assembly is inverted to that of FIG. 2A so that the permanent magnet is positioned at the inside of the magnetic assembly while the pole piece is provided at the outside of the magnetic assembly.

As shown in the cross sectional view of FIG. 2A, similar to the structure of FIG. 1, a loudspeaker 111a includes a speaker cone 113 forming a diaphragm 117, a coil bobbin 125, and a dust cap 115. The diaphragm 117, the dust cap 115 and the coil bobbin 125 are attached to one another (diaphragm assembly). A voice coil 127 is attached to the coil bobbin 125 around its surface. The voice coil 127 is connected to suitable leads (not shown) to receive an electrical input signal through electrical terminals.

The diaphragm 117 is provided with an upper half roll 121 at its peripheral made of flexible material. The diaphragm 117 connects to a speaker frame 119 at an upper half roll 121 by means of, for example, an adhesive. At about the lower third of the speaker frame 119, the intersection of the diaphragm 117 and the coil bobbin 125 is connected to the speaker frame 119 through a spider 123 which works as an inner suspension. The spider 123 is typically made of a flexible material for flexibly suspending the diaphragm 117, the coil bobbin 125 and the voice coil 127. Consequently, the upper half roll 121 and the spider 123 allow the flexible vertical movements of the diaphragm 117 as well as limit or damp the movements of the diaphragm 117 when it is vibrated in response to the electrical input signal to the voice coil 127.

An air gap 141 and annular members including a pole piece 139, a permanent magnet 133, and an upper plate (top plate) 135 make up a magnetic assembly 137a. In this example, the magnetic assembly 137a has a back plate 138 integrally formed with the pole piece 139 at its bottom. The pole piece 139 has a central opening 140 for dissipating heat generated by the voice coil 127 when the electric power (input signal) is supplied to the voice coil 127.

In this example, the permanent magnet 133 is disposed between the upper plate 135 and the back plate 138 of the pole piece 139. The upper plate 135 and the pole piece 139 are constructed from a material capable of carrying magnetic flux, such as steel. Therefore, a magnetic path or circuit is created in the magnetic assembly 137a through the pole piece 139, the upper plate 135, the permanent magnet 133 and the back plate 138 through which the magnetic flux runs.

The air gap 141 is created between the pole piece 139 and the upper plate 135 (and the permanent magnet 133) in which the voice coil 127 and the coil bobbin 125 are inserted in the manner shown in FIG. 2A. Thus, when the electrical input signal is applied to the voice coil 127, the current flowing in the voice coil 127 and the magnetic flux (flux density) interact with one another. This interaction produces a force on the voice coil 127 which is proportional to the product of the current and the flux density. This force activates the reciprocal movement of the voice coil 127 on the coil bobbin 125, which vibrates the diaphragm 117, thereby producing the sound waves. Therefore, within the context of the present invention, the magnetic assembly 137a is also referred to as a “motor structure” or a “motor” and a combination of the diaphragm 117 and the voice coil 127 on the coil bobbin 125 is also referred to as a “force transfer assembly”.

In the loudspeaker 111a of the present invention shown in FIG. 2A, on the top of the magnetic assembly 137a, a plurality of cut-outs (magnetic gap) 145 are created to receive corresponding suspension elements of the spider 123. Namely, the suspension element can be inserted in an inside space of the cut-out 145 when the loudspeaker is assembled, which makes it possible to dramatically reduce the distance between the diaphragm 117 and the magnetic assembly 137a. In other words, in the present invention, it is possible to dramatically reduce the vertical length of the coil bobbin 125, thereby dramatically reducing the thickness, i.e., mounting depth, of the loudspeaker 111a. Further, in the present invention, because of the cut-outs 145, the spider 123 is allowed to be placed further away from the diaphragm 117 to improve axial stability so that the loudspeaker is less prone to “rocking” which may affect the loudspeaker's sensitivity and reliability.

In this example, the cut-out 145 is created within the upper (top) plate 135, however, it may be formed further deep in the magnetic assembly 137a. The size of the cut-out 145 and position of the spider 123 are determined so that the spider 123 will not touch the magnetic assembly 137a when vibration amplitudes of the voice coil 127 and coil bobbin 125 reach the lowermost position in the air gap 141 during the operation of the loudspeaker 111a. The deeper the cut-out 145, the shorter the distance between the diaphragm 117 and the magnetic assembly 137a, i.e., the thinner it becomes the overall size of the loudspeaker 111a. However, if the size (depth) of the cut-out 145 is too large to reach the permanent magnet 133, it may adversely affect the magnetic characteristics of the magnetic assembly 137a which will ultimately impair the overall quality and performance of the loudspeaker 111a. Thus, a proper balance and compromise must be made when determining the size and shape of the cut-out 145.

In the loudspeaker 111b in FIG. 2B, the structure of the magnetic assembly 137 is inverted to that of FIG. 2A described above with respect to a center axis (not shown). Namely, the pole piece 139 is positioned at an outside of the magnetic assembly 137b with respect to the center axis while the top plate 135, permanent magnet 133, and back plate 138 are provided at an inside of the magnetic assembly 137b. A plurality of cut-outs 145 are formed on a top of the magnetic assembly 137b at its outside thereof with respect to the air gap 141, i.e., on the pole piece 139, to receive therein the corresponding suspension elements of the spider 123.

Typically, this inverted structure of the magnetic assembly 137b is implemented when high quality magnetic materials such as neodymium is used for the permanent magnet 133. In FIG. 2B, the cut-outs 145 for clearance of the spider 123 are provided at the top of the pole piece (yoke) 139. Compared to the design shown in FIG. 2A, the cut-outs 145 in FIG. 2B can be formed deeper without impairing the performance property of the loudspeaker since the pole piece 139 is integral from the top to the bottom of the magnetic assembly 137b. The present invention of FIGS. 2A and 2B enables to eliminate most suspension related non-linearities due to manufacturing tolerance or control in typical resin/cloth based designs.

As noted above with reference to FIG. 2B, the present invention can be applied to the inverted structure (inner magnet structure) of magnetic assembly 137 so that the cut-outs 145 are formed on the pole piece 139 rather than on the top plate 135 of the magnetic assembly 137. The present invention can be applied to the magnetic assembly both in FIGS. 2A and 2B, however, the embodiment of FIG. 2B may be more advantageous since the cut-outs 145 can be formed deeper than that of FIG. 2A. Although the present invention can be applied to the both cases, it should be noted that the following descriptions on the present invention will be made for the case of the inverted structure of the magnetic assembly.

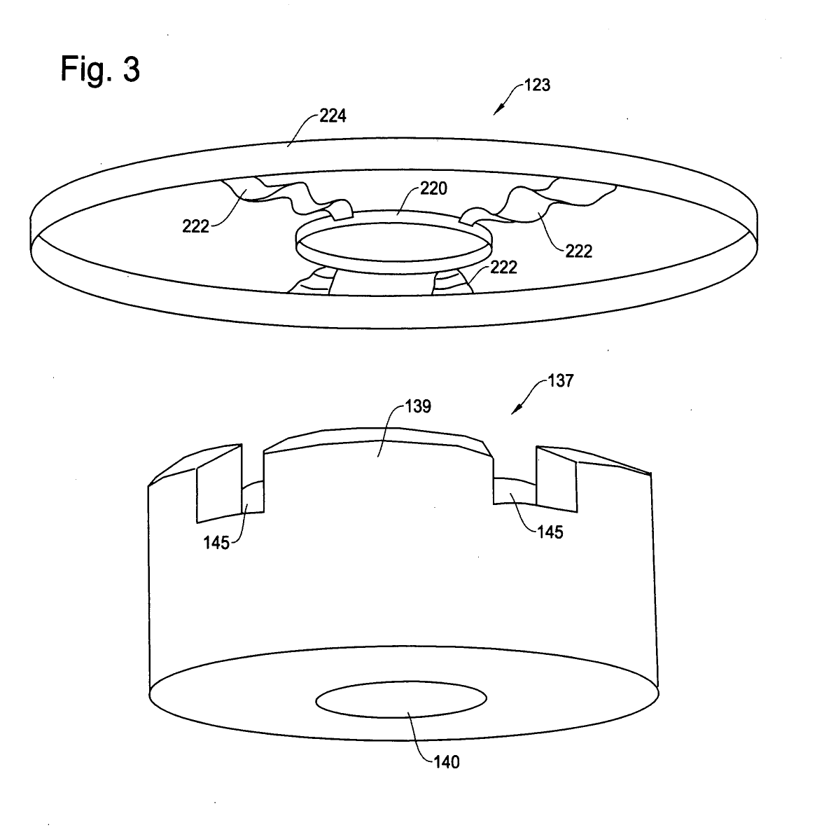

FIG. 3 is a perspective view showing an example of the spider 123 and the magnetic assembly 137 incorporated in the loudspeaker of the present invention, which is viewed from the lower position. The spider 123 shown in the upper part of FIG. 3 has an inner ring 220, a plurality of suspension elements 222, and an outer ring 224. When assembled in the loudspeaker, the inner ring 220 will be connected to the coil bobbin 125 on which the voice coil 127 is attached, and the outer ring 224 will be connected to the speaker frame 119 in a manner shown in FIGS. 2A and 2B. To suspend the voice coil 127 and the diaphragm 117 in a flexible manner, the each of the suspension element 222 is made of elastic materials and curved in a wave-like shape.

The magnetic assembly 137 shown in the lower part of FIG. 3 has a plurality of cut-outs 145 that correspond to the suspension elements 222 of the spider 123. The cut-outs 145 are formed on the pole piece 139 of the magnetic assembly. The central opening 140 is shown at the bottom of the magnetic assembly 137. When assembled, each of the suspension elements 222 of the spider 123 will be inserted in the space of the cut-out 145 in a manner that the suspension element 222 will not touch the magnetic assembly 137 even when the maximum amplitude of the vibration of the diaphragm 117 (and voice coil 127) is produced by the electric signal to the voice coil 127.

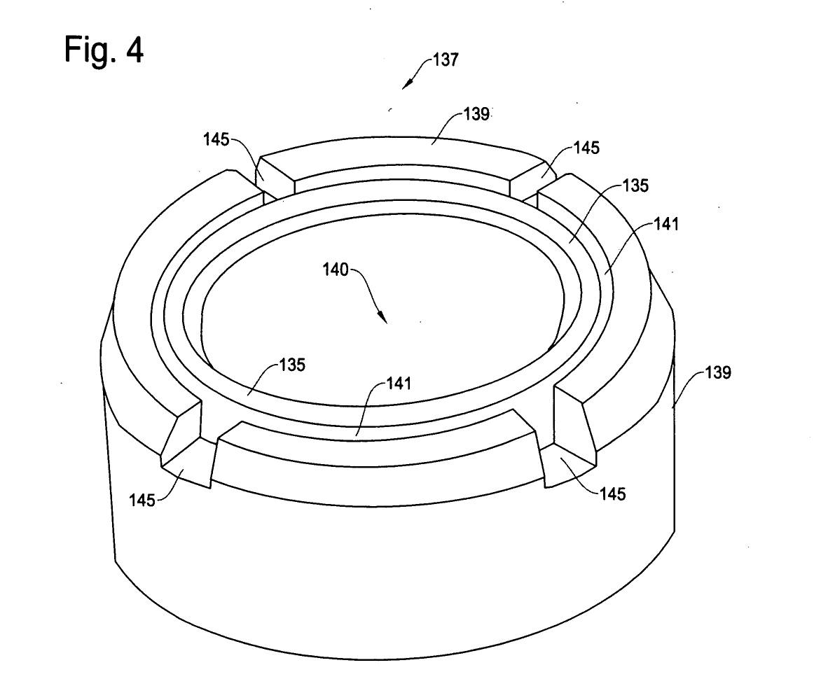

FIG. 4 is a perspective view showing an example of outer structure of the magnetic assembly 137 incorporated in the loudspeaker of the present invention, which is viewed from the upper position. Similar to FIG. 3, the magnetic assembly 137 in FIG. 4 shows the basic concept of the present invention for reducing the mounting depth of the loudspeaker. Namely, the magnetic assembly 137 has a plurality of cut-outs 145 that correspond to the suspension elements 222 of the spider 123.

The cut-outs 145 are formed on the pole piece (outer yoke) 139 of the magnetic assembly as described above with reference to FIG. 2B. The central opening 140 is formed from the top to the bottom of the magnetic assembly 137 (see also FIG. 2B). When assembled in the loudspeaker, each of the suspension elements 222 of the spider 123 will be inserted in the space of the cut-outs 145 in a manner that the suspension element 222 will not touch the magnetic assembly 137 even when the diaphragm 117 (and voice coil 127) is vibrated with the maximum amplitude.

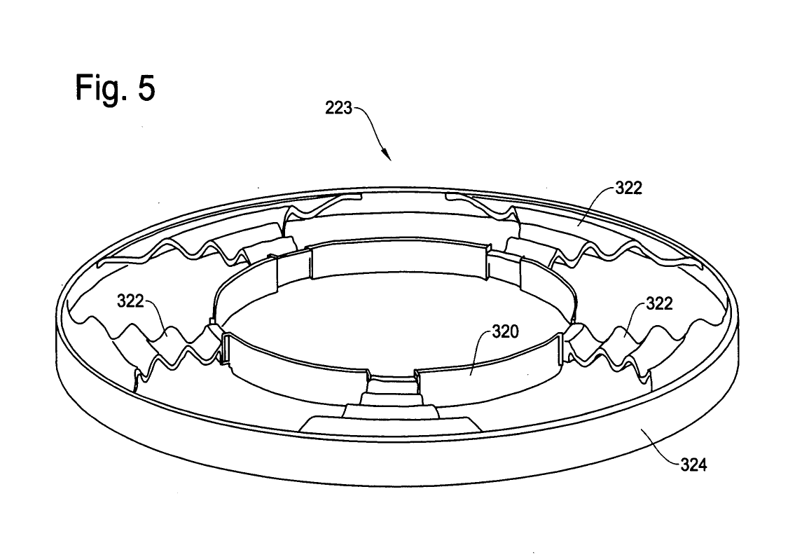

FIGS. 5-9 show examples of the structure of the loudspeaker implementing the present invention. FIG. 5 is a perspective view showing an example of more detailed structure of the spider which is applied to the loudspeaker of the present invention. It should be noted that the embodiment of the spider 223 in FIG. 5 is not necessary be consistent with the structure of the magnetic assembly of FIG. 3 or FIG. 4 since the numbers of suspension elements and the cut-outs are different from one another.

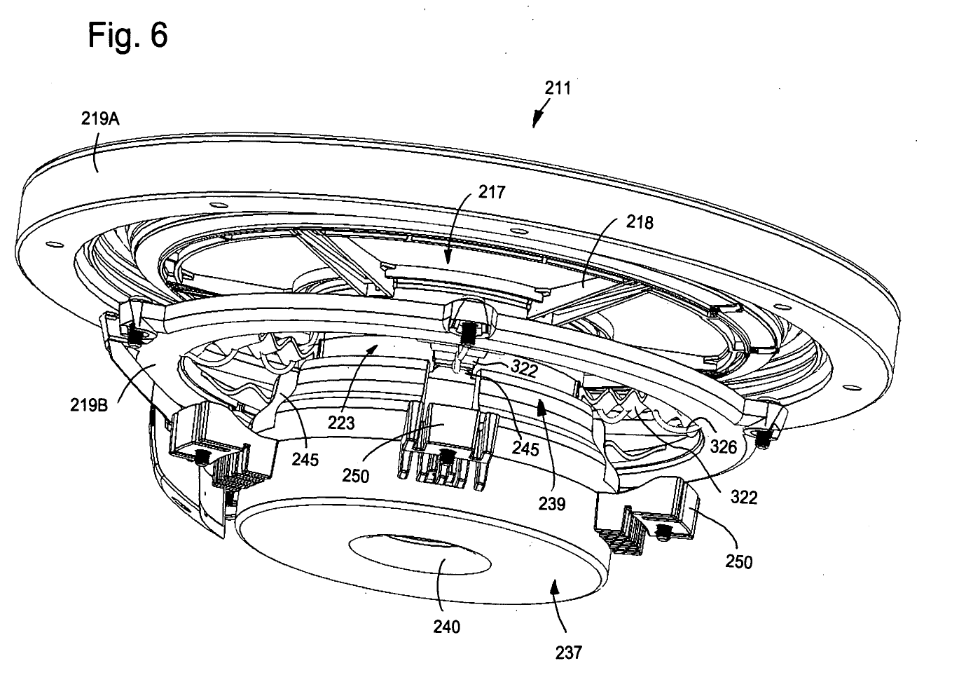

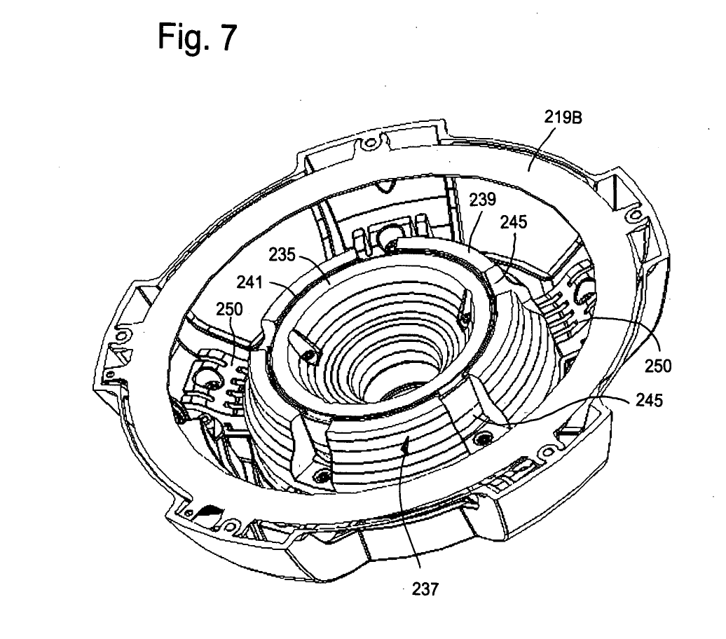

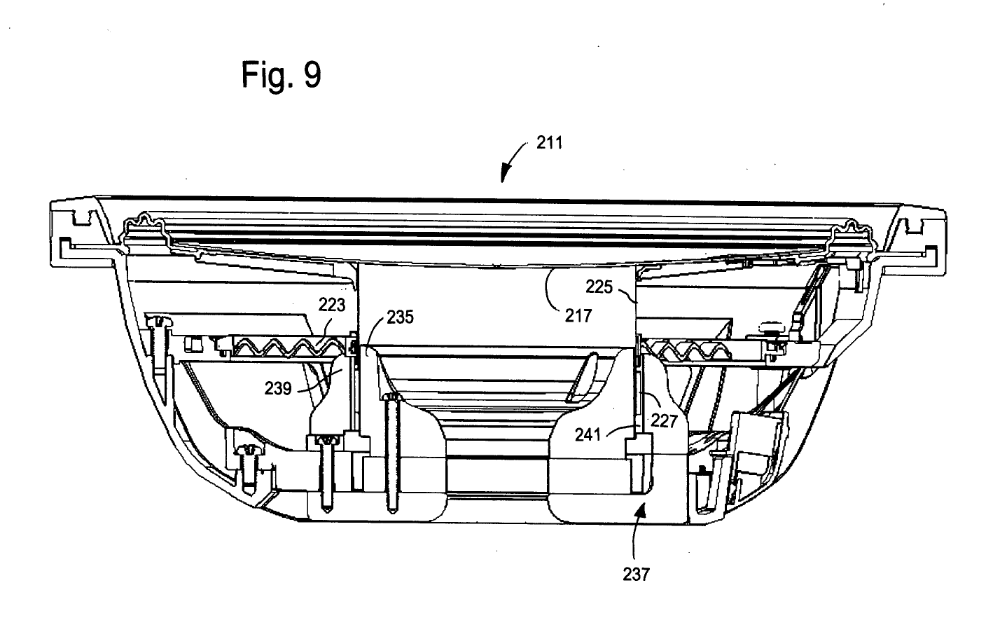

In the example of FIG. 5, the spider 223 has an inner ring 320, a plurality of suspension elements 322, and an outer ring 324. The spider 223 allows or damps the flexible vertical movements of the diaphragm and voice coil when they are vibrated in response to the electrical input signal. In other words, the spider 223 controls the stability of the movement of the diaphragm and voice coil. When assembled in the loudspeaker, the inner ring 320 will be connected to the coil bobbin 225 (FIGS. 7 and 9) on which the voice coil 227 (FIG. 9) is attached, and the outer ring 324 will be connected to the speaker frame 219A (FIG. 6).

To suspend the voice coil 227 and the diaphragm 217 in a flexible manner, each of the suspension element 322 is made of elastic materials and alternately curved in a wave-like shape. Further, the width of the suspension element 322 is increased toward the outer ring 324 to achieve an appropriate strength and elastic force for suspending the voice coil and the diaphragm. In contrast, the width of the suspension element 322 is decreased near the inner ring 320 to be inserted in the space of the cut-out 245 (FIG. 6) formed on the magnetic assembly. Furthermore, this spider 223 can be manufactured with repeatability and control. This design of spider is intended to be either stamped from a foam, or injection-molded/co-molded onto mounting collars (inner and outer ring) for attachment to the voice coil in a high-excursion, high-stress design.

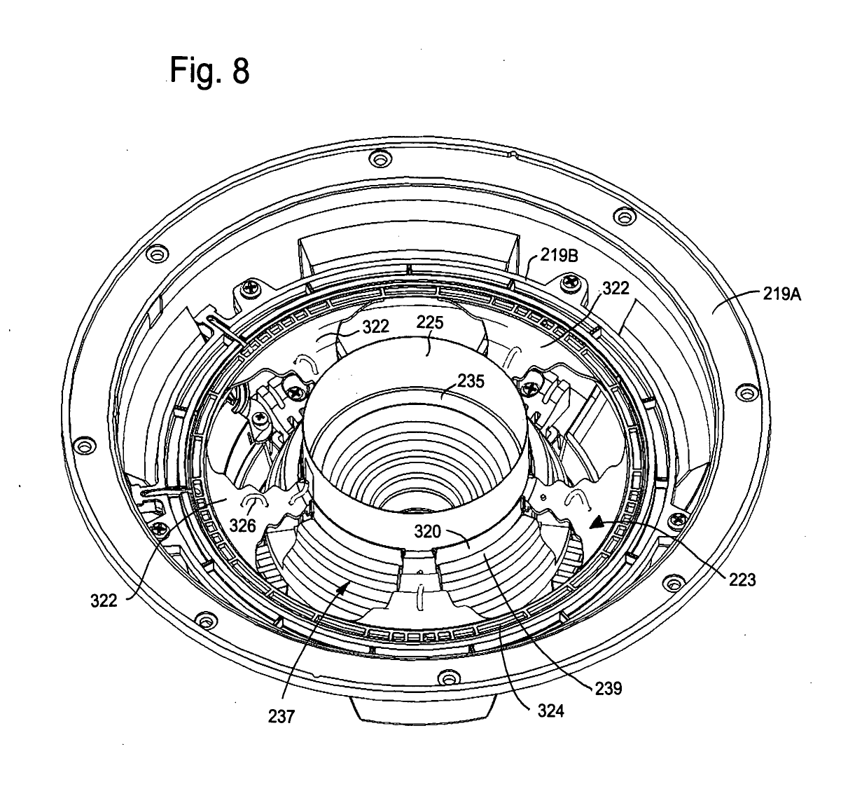

FIG. 6 is a perspective view showing an example of structure of a loudspeaker 211 implementing the present invention in which an upper part and a lower part are separated from one another to show an inner structure the loudspeaker. On an upper speaker frame 219A of the loudspeaker 211, a diaphragm assembly (force transfer assembly) 217 is attached which is mainly configured by diaphragm frames 218 and a voice coil 227 on a coil bobbin 225 (FIG. 8). On a lower speaker frame 219B of the loudspeaker 211, a magnetic assembly 237 (motor structure) having the cut-outs 245 on the pole piece 239 thereof and the spider 223 are mounted.

In the loudspeaker 211 of the present invention, the lower part (coil bobbin) of the diaphragm assembly (force transfer assembly) 217 may pass down through the air gap 241 (FIGS. 7 and 9) of the magnetic assembly 237 (motor structure). As noted above, since the cut-outs 245 (cut-outs 145 in FIGS. 2A-4) are formed on the top of the magnetic assembly 237 (magnetic assembly 137a and 137b in FIGS. 2A-4), the suspension elements 322 of the spider 223 (spider 123 in FIGS. 2A and 2B) can pass through the inside space of the cut-outs 245.

Thus, the vertical length of the coil bobbin 225 (coil bobbin 125 in FIGS. 2A and 2B) can be dramatically reduced, thereby reducing the thickness, i.e., mounting depth, of the loudspeaker 211 (loudspeaker 111a and 111b in FIGS. 2A and 2B). Further, in the present invention, it is also possible to design so that the diaphragm frames 218 of the diaphragm assembly 217 are aligned with the suspension elements 322 of the spider 223 close to one another. In such a design, the diaphragm frames 218 and the suspension elements 322 can pass through the cut-outs 245 on the magnetic assembly 237, resulting in a stronger structure of the diaphragm assembly 217.

Although an upper plate 235 (FIG. 7) and a permanent magnet of the magnetic assembly 237 are not shown in FIG. 6, a central opening 240 of the magnetic assembly 237 is shown at the bottom. In the example of FIG. 6, on the suspension element 322 of the spider 223, a cable 326 is mounted to provide an electric signal to the voice coil 227 (FIG. 9). Further in the example of FIG. 6, heat sinks 250 are provided on the outer surface of the magnetic assembly 237 to dissipate the heat produced by the voice coil 227 during the operation of the loudspeaker.

FIG. 7 is a perspective view showing the lower part of the structure of the loudspeaker implementing the present invention which includes the magnetic assembly and the lower speaker frame. FIG. 7 shows the situation where the spider 223 is not mounted on the lower speaker frame 219B to more clearly show the cut-outs 245 formed on the magnetic assembly 237. The cut-outs 245 at the top of the magnetic assembly 237 allows for maximum efficiency by not cutting the lower portion of the magnetic circuit, leaving an efficient magnetic path while allowing for maximum excursion of the diaphragm and voice coil in the air gap 241.

The air gap 241 is formed between the pole piece 239 and the upper plate 235 of the magnetic assembly 237 in which the coil bobbin 225 and voice coil 227 will be inserted when the upper part of the loudspeaker is attached in the final form. As noted above with reference to FIG. 2B, the present invention can be applied to the inverted structure of magnetic assembly so that the cut-outs 245 are formed on the pole piece 239 at the outside rather than on the upper (top) plate 235 and permanent magnet at the inside. In FIG. 7, the upper part of the heat sink 250 is shown at the outside of the magnetic assembly 237.

FIG. 8 is a perspective view showing the inner structure of the loudspeaker implementing the present invention which includes the magnetic assembly, the upper and lower speaker frames, and the spider. FIG. 8 shows the situation where the spider 223 is mounted on the lower speaker frame 219B but the diaphragm assembly 217 is not mounted on the upper speaker frame 219A to more clearly show the relationship between the cut-outs 245 and the spider 223. The coil bobbin 225 is inserted in the gap 241 formed between the pole piece 239 and the top plate 235 of the magnetic assembly 237.

As noted above with reference to FIG. 5, in the spider 223 of the present invention, each of the suspension element 322 is made of elastic materials and has a wave-like shape. Further, the width of the suspension element 322 is increased toward the outer ring 324 to achieve an appropriate strength and elastic force for suspending the voice coil and the diaphragm. In contrast, the width of the suspension element 322 is decreased toward the inner ring 320 to be inserted in the space of the cut-out 245 formed on the magnetic assembly 237. The spider 223 is designed to allow the high-excursion of diaphragm assembly 317 while maintaining the appropriate sound quality without distortion.

FIG. 9 is a cross sectional view showing an example of inner structure of the loudspeaker to illustrate the effect of the present invention. In the loudspeaker 211 of the present invention, as described above, the cut-outs 245 (FIG. 7) are formed on pole piece 239 of the magnetic assembly 237. Accordingly, the coil bobbin 225, the voice coil 227 and the diaphragm 217 can be positioned dramatically lower than the conventional technology by shortening the length of the coil bobbin 225 since the spider 223 can pass through the cut-outs 245.

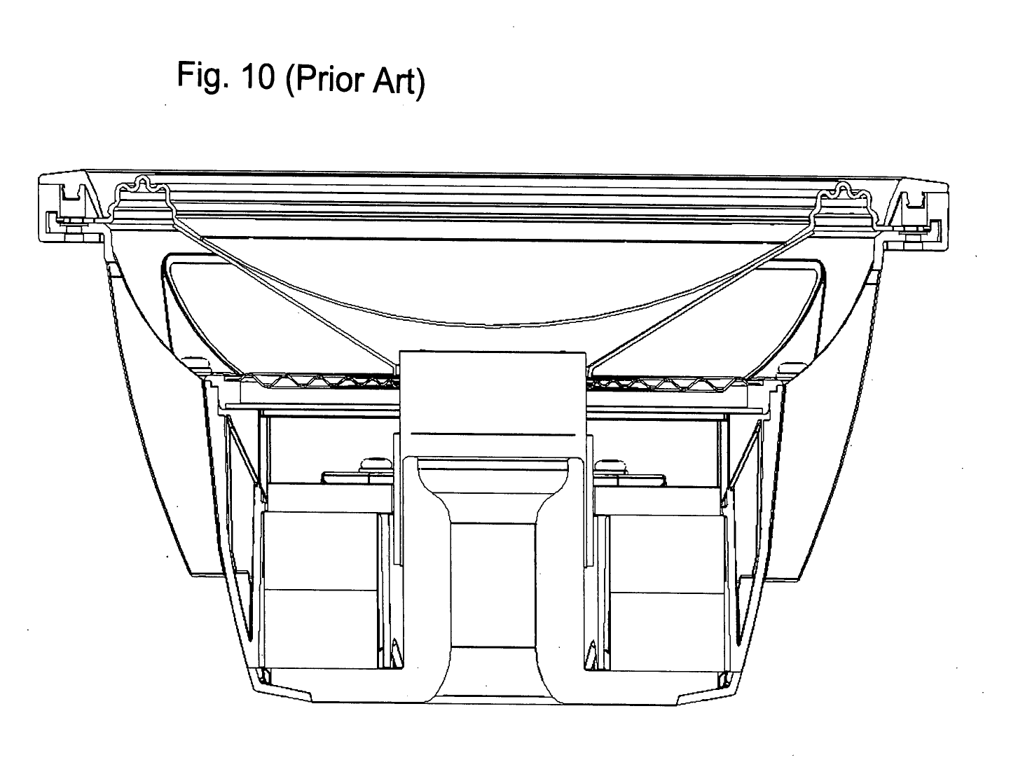

FIG. 10 is a cross sectional view showing an example of inner structure of the loudspeaker in the conventional technology. As can be seen, there is a significant distance between the spider and the top of the magnetic assembly to maintain the clearance between them, which requires a substantial length of the coil bobbin. It is apparent that the thickness of the loudspeaker 211 shown in FIG. 9 is dramatically reduced from that of the conventional technology shown in FIG. 10.

As has been described above, according to the present invention, on the top of the magnetic assembly, a plurality of cut-outs (magnetic gap) are provided to receive the corresponding suspension elements of the spider. Thus, each of the suspension elements can be'inserted in an inside space of the cut-out when the loudspeaker is assembled, which makes it possible to dramatically reduce the distance between the diaphragm and the magnetic assembly. Consequently, it is possible to dramatically reduce the vertical length of the coil bobbin, thereby dramatically reducing the thickness, i.e., mounting depth, of the loudspeaker. The basic concept of the present invention can be applied to a variety of loudspeakers, ranging from mid-range, coaxial speakers, all the way to high-excursion subwoofers.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A loudspeaker, comprising:
a speaker frame;
a diaphragm connected to the speaker frame in a manner capable of vibration;
a voice coil connected to the diaphragm through a coil bobbin to receive an electric signal to vibrate the diaphragm;
a spider connected to the speaker frame at one end and to the diaphragm at another end for supporting the diaphragm and the voice coil in a flexible manner;
a magnetic assembly including a top plate, a permanent magnet and a pole piece for creating a magnetic circuit for interaction with the voice coil inserted in an air gap of the magnetic assembly; and
a plurality of cut-outs formed on a top of the magnetic assembly at an outside thereof with respect to the air gap to receive therein corresponding suspension elements of the spider.

2. A loudspeaker as defined in claim 1, further comprising a central opening formed at a center of the magnetic assembly in an axial direction to dissipate heat generated by the voice coil.

3. A loudspeaker as defined in claim 1, wherein the magnetic assembly includes a back plate which is integrally formed with the pole piece.

4. A loudspeaker as defined in claim 3, wherein the air gap of the magnetic assembly to receive the voice coil is created between the pole piece and a combination of the top plate, the permanent magnet, and the back plate.

5. A loudspeaker as defined in claim 4, wherein the magnetic assembly is configured so that the pole piece is positioned at an inside of the magnetic assembly with respect to a center axis while the combination of the top plate, the permanent magnet and the back plate is positioned at an outside of the magnetic assembly with respect to the center axis.

6. A loudspeaker as defined in claim 5, wherein the plurality of cut-outs for receiving the suspension elements of the spider are formed on the top plate of the magnetic assembly.

7. A loudspeaker as defined in claim 4, wherein the magnetic assembly is configured so that the pole piece is positioned at an outside of the magnetic assembly with respect to a center axis while the combination of the top plate, the permanent magnet and the back plate is positioned at an inside of the magnetic assembly with respect to the center axis.

8. A loudspeaker as defined in claim 7, wherein the plurality of cut-outs for receiving the suspension elements of the spider are formed on a top of the pole piece of the magnetic assembly.

9. A loudspeaker as defined in claim 1, wherein a size of the cut-outs for receiving the suspension elements of the spider and a position of the spider are determined so that the suspension element of the spider will not touch the magnetic assembly when vibration amplitudes of the voice coil reach a lowermost position in the air gap during the operation of the loudspeaker.

10. A loudspeaker as defined in claim 1, wherein the spider has an inner ring and an outer ring between which a plurality of suspension elements are connected.

11. A loudspeaker as defined in claim 10, wherein the inner ring of the spider is connected to the coil bobbin having the voice coil thereon, and the outer ring of the spider is connected to the speaker frame.

12. A loudspeaker as defined in claim 11, wherein each of the suspension elements is made of elastic material and has a wave-like shape.

13. A loudspeaker as defined in claim 12, wherein a width of each suspension element is increased toward the outer ring while the width of the suspension element is decreased toward the inner ring to be inserted in the cut-out formed on the magnetic assembly.

14. A loudspeaker as defined in claim 1, wherein the speaker frame includes an upper speaker frame and a lower speaker frame, wherein the diaphragm is mounted on the upper speaker frame, and the magnetic assembly and the spider are mounted on the lower speaker frame.

15. A loudspeaker as defined in claim 1, wherein the diaphragm includes diaphragm frames which are aligned with the suspension elements of the spider close to one another so that both the diaphragm frames and the suspension elements are inserted in the cut-outs on the magnetic assembly when assembled.
